(19) United States
(12) Patent Application Publication
(10) Pub. No.: US 2024/0028700 A1
(43) Pub. Date: Jan. 25, 2024

(54) RANDOM PASSWORD GENERATION

(71) Applicant: HEWLETT-PACKARD DEVELOPMENT COMPANY, L.P., Spring, TX (US)

(72) Inventors: Zhiwei Yu, Shanghai (CN); Charles Cody Gerhardt, Amelia, OH (US)

(73) Assignee: HEWLETT-PACKARD DEVELOPMENT COMPANY, L.P., Spring, TX (US)

(21) Appl. No.: 17/867,767

(22) Filed: Jul. 19, 2022

(51) Int. Cl. G06F 21/46; G06F 21/31

(52) U.S. Cl. CPC G06F 21/46; G06F 21/31

(57) ABSTRACT

In an example in accordance with the present disclosure, a random password generation device is described. The device includes a processor and a memory device communicatively coupled to the processor. The memory device includes instructions executable by the processor. The instructions include instructions to determine a random password parameter, wherein the random password parameter defines a generated random password. The instructions also include instructions to, responsive to a generation trigger, generate a random password based on the random password parameter, wherein the random password is to grant a user access to an application. The instructions also include instructions to, responsive to entry of a predetermined user command, reset the random password to a user-defined password.

### BACKGROUND

Computing devices are used to execute a wide variety of operations from generating digital content, writing program code, facilitating online communication and a vast array of other operations. To access the computing device, the applications that execute on the computing device, or the program code that defines the operation of the computing device, a user may be required to enter a password. That is, computing device passwords gate access to the computing device and its program code in order to safeguard against malicious or inadvertent access which may compromise the application and/or program code and the data contained therein.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a diagram of a device for generating a random password, according to an example of the principles described herein.

FIG. 2 is a flowchart of a method for generating a random password, according to an example of the principles described herein.

FIG. 3 is a diagram of a device for generating a random password, according to an example of the principles described herein.

FIG. 4 is a flowchart of a method for generating a random password, according to an example of the principles described herein.

FIG. 5 depicts a non-transitory machine-readable storage medium for generating a random password, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations that coincide with the description; however, the description is not limited to the examples and/or implementations provided in the drawings.

### DETAILED DESCRIPTION

Passwords control access to computing devices, applications running on computing devices, and interfaces where program code for the computing device may be accessed. Without passwords, any user may be able to gain unauthorized access to the computing device, applications, and/or program code. For any number of reasons, unrestricted access to a computing device and the applications and program code executing thereon may be undesirable. As a first example, an application may include sensitive or confidential information for a user. Allowing unfettered access would allow any user to view the sensitive and/or confidential information. As another example, an application may require payment of a fee or other subscription to use the application functionality. In this example, a password allows for identification of a paying subscriber as opposed to a non-paying user attempting to access the fee-based application without having paid the fee.

As yet another example, some computing devices operate with an open-source operating system where any user may access and adjust the open-source program code. While such open-source systems provide great flexibility to tailor the operation of a computing device to a specific intent, allowing unrestricted access to the program code may impede the goal of specific computing operation as any user may alter the program code that is otherwise established for a specific purpose.

For example, an organization may have generated open-source code specific to the organization's accounting department. If any user of the organization were able to access this open-source code, that user may be able to adjust the open-source code, deviating from an intended functionality and/or altering the program code in a way that makes it unable to function as intended and thus frustrating the purpose of the original open-source code. For an organization or entity serving many users, this problem is exacerbated if each user has the ability to alter and manipulate the open-source code. In other words, it may be desirable to restrict access to the open-source code to a select number of users who are authorized to change the open-source code. As such, the interface to alter the open-source code may be gated by entry of username and/or password.

While passwords in any of these examples may provide an increased measure of security, for any number of reasons, existing password systems may be insufficient. For example, passwords are saved to memory device. Despite data protection measures of existing systems, these memory devices are susceptible to hacking or other unauthorized access. As such, the data stored therein, e.g., passwords may be acquired by unauthorized parties such that the application or data that they are intended to protect is exposed to some degree.

Moreover, memory storage is a finite resource and storage of passwords may take up valuable space on the memory device which may otherwise be used to store other information. Again, for large organizations with many users, password storage space may be a non-trivial amount.

Lastly accessing passwords and confirming user identity may consume processing bandwidth, which like memory usage, may be utilized by other operations.

Accordingly, the present specification describes a device, method, and computer program product that provide even more security by making the password more difficult to bypass. Specifically, the present specification describes a device, method, and computer program product that periodically or cyclically change a password to a random password based on certain randomization parameters. Examples of such parameters include a password length, a presence of special characters, a presence of numbers and capital letters.

Accordingly, rather than relying on security based on a user-generated password, access to the computing device, application, or operating system program code is gated by a randomly generated password and no user knows the password as it is periodically and randomly changed. When a user would like to access the computing device, application, or program code, the user may execute an operation to set a temporary password, following which they may access the underlying resources.

As such, the present specification enhances the operation of a computing device by offloading password storage. Specifically, the risk of password misappropriation is reduced or alleviated as the passwords are erased and no user-defined password is stored on the computing device. Thus, while memory devices may be susceptible to hacking, as the present device does not store passwords on the memory device, access to underlying content is still protected and gated.

Moreover, memory device storage space is conserved, i.e., less memory is used up, as the passwords of the potentially hundreds or thousands of users is not stored thereon. As if that were not enough, the computing device may operate more quickly as a process to verify a user-defined password is bypassed in favor of the generation and resetting of a random password to allow a user access to the underlying content.

Specifically, the present specification describes a random password generation device. The random password generation device includes a processor and a memory device communicatively coupled to the processor, the memory device which includes instructions executable by the processor. The instructions include instructions to determine a random password parameter, wherein the random password parameter defines a generated random password. The instructions also include instructions to, responsive to a generation trigger, generate a random password based on the random password parameter, wherein the random password is to grant a user access to an application. The instructions also include instructions to, responsive to entry of a predetermined user command, reset the random password to a user-defined password.

The present specification also describes a method. According to the method, a set of random password parameters are determined. The set of random password parameters defines a generated random password. A generation trigger event is detected and responsive to such 1) an existing password is erased and 2) a random password is generated based on the set of random password parameters. The random password is to grant a user access to an application. Responsive to entry of a predetermined user command, the random password is reset to a user-defined password.

The present specification also describes a non-transitory machine-readable storage medium encoded with instructions executable by a processor. The machine-readable storage medium includes instructions to execute a first program instruction set. The first program instruction set includes instructions to 1) determine a set of random password parameters and 2) detect occurrence of a generation trigger event. Responsive to the occurrence of the generation trigger event, the first program instruction set includes instructions to 1) erase an existing password and 2) generate a random password based on the set of random password parameters. The machine-readable storage medium also includes instructions to execute a second program instruction set, the second program instruction set to, responsive to entry of a predetermined user command, reset the random password to a user-defined password.

As described above, such a device, method, and machine-readable storage medium may, for example, 1) provide a computing device with greater data security; 2) protects against cyberattack; 3) are more robust against nefarious attempts to circumvent password authentication; 4) alleviate complications arising from forgotten passwords; 5) provide simple access to authorized users; 6) uses up less memory resources; and 7) increases processing bandwidth. However, it is contemplated that the device, method, and machine-readable storage medium disclosed herein may address other matters and deficiencies in a number of technical areas, for example.

As used in the present specification and in the appended claims, the term “a number of” or similar language is meant to be understood broadly as any positive number including 1 to infinity.

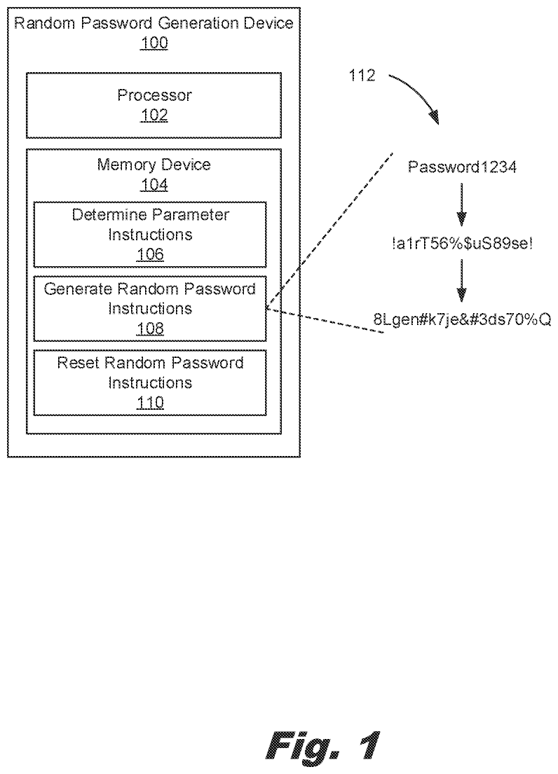

Turning now to the figures, FIG. 1 is a diagram of a random password generation device (100) for generating a random password, according to an example of the principles described herein. That is, the present random password generation device (100) provides additional password security by intermittently replacing an existing password with a random password, which random password is generated based on a set of random password parameters. The random password generation device (100) may be implemented on any number of computing devices including desktop computers, laptop computers, mobile devices, servers, computing devices that rely on remote operating systems, and gaming systems among others. While particular reference is made to particular computing devices, the random password generation device (100) may be implemented as any number of computing devices with a processor (102) and a memory device (104).

That is, the random password generation device (100) includes a processor (102) and a memory device (104) communicatively coupled to the processor (102). The processor (102) includes the circuitry to retrieve executable code, i.e., instructions, from the memory device (104) and execute the executable code. As specific examples, the random password generation device (100) as described herein may include machine-readable storage medium, machine-readable storage medium and a processor, an application-specific integrated circuit (ASIC), a semiconductor-based microprocessor, and a field-programmable gate array (FPGA), and/or other hardware device.

As used in the present specification an in the appended claims, the term “memory device” includes a non-transitory storage medium, which machine-readable storage medium may contain, or store machine-usable program code for use by or in connection with an instruction execution system, apparatus, or device. The memory device (104) may take many forms including volatile and non-volatile memory devices (104). For example, the memory device (104) may include Random-Access Memory (RAM), Read-Only Memory (ROM), optical memory disks, and magnetic disks, among others. The executable code may, when executed by the processor (102), cause the processor (102) to implement the functionality described herein. The memory device (104) may include a single memory element or multiple memory elements.

As described above, the memory device (104) includes instructions executable by the processor (102). The instructions are executable by the processor (102) to reset a password to a random password. As such, the random password generation device (100) blocks access to the underlying content when a character string that does not match the random password is entered. By comparison, when the random password is temporarily reset to a user-defined password, the random password generation device (100) may grant access to the user to access the underlying content.

The password that is reset may be of a variety of types. For example, the password and the random password that replaces the password may be system passwords that initialize a computing device. For example, when a computer shuts down, or enters a sleep state, a user may be prompted to enter a password to wake the computer up from the sleep state and start operation. This is an example of a system password that may be reset by the random password generation device (100).

In another example, the random password and the temporary user-defined password may grant the user access to alter an operating system of a computing device. That is, computing devices have program code that defines the operation of the computing device. The operating system program code may be open source, meaning users are granted permission to alter the operating system program code to accomplish an intended functionality. Such open-source program code may be gated by a password which is available to an administrator. Such a password to access the operating system program code may be referred to as a “root” password. In other words, the password that is reset may be a password that grants root privileges, or full access to files, applications, and system functions. Such root privileges may be gated to certain individuals and may not be granted to all users of the open-source program code.

To provide the desired additional security, the memory device (104) may store a variety of instructions. Specifically, the memory device (104) includes determine parameter instructions (106) which are executable by the processor (102) to determine a random password parameter. The random password parameter is a parameter that defines the generated random password. That is, there are a number of parameters that may guide the generation of a random password and the determine parameter instructions (106) may identify these parameters and pass the parameters to the generate random password instructions (108) such that a random password is generated accordingly.

As a particular example, a parameter for the random password may be a password length parameter. A parameter length parameter may prescribe a minimum and/or maximum length of a random password to be generated. Another example of a random password parameter is a special character parameter. The special character parameter may indicate whether or not a special character should be included in the random password and may identify a pool of special characters from which a special character may be selected for inclusion in the random password. The special character parameter may also prescribe a number of special characters to include in the random password and may also indicate certain special characters that are to be excluded from any generated password.

Another example of a random password parameter is a number character parameter. The number character parameter may indicate whether or not a number character should be included in the random password and may identify a pool of numbers from which a number character may be selected for inclusion in the random password. The number character parameter may also prescribe a quantity of number characters to include in the random password and may also indicate certain number characters that are to be excluded from any generated password.

Another example of a random password parameter is a character case parameter which indicates whether characters of a particular case (i.e., upper or lower) should be included in the random password. The character case parameter may also prescribe an upper and lower limit on the number of uppercase and/or lowercase characters to include in the random password. While particular reference is made to particular parameters, any variety of parameters, and any combination of the above-noted parameters or other parameters, may be implemented in accordance with the principles described herein.

As such, the determine parameter instructions (106), when executed by the processor (102) protect the computing device against cyberattack and hacking. That is, the randomization of a password prevents a user from gaining unauthorized access to the underlying content by adding an extra degree of security in the form of a randomized password, rather than a user-defined password that is static and may remain in effect for a longer period of time than a password that is randomly generated iteratively over time.

The memory device (104) also includes generate random password instructions (108) that generate the random password based on the random password parameter, or set of random password parameters. That is, the generate random password instructions (108) may erase an existing password (112) and generate a string of characters that 1) complies with the random password parameters and 2) is used to gate access to the computing device, application, or program code interface. For example, the random password parameters may indicate a password length of 16 characters, a password with 4 special characters, 5 numbers, and 2 uppercase characters. As such, the generate random password instructions (108) may erase an existing password of “Password1234” with the random password “!a1rT56%$uS89se!” as indicated in FIG. 1. As the password has been randomized, a malicious user who may have gained unauthorized access to the password “Password1234” would not be able to access the underlying content due to the random nature and complexity of the random password. Thus, system security is enhanced. Moreover, by erasing an existing password from the memory device (104), the computing device is protected against cyberattack as the user-defined password is not stored on a hackable memory device (104).

The random password may be generated responsive to a generation trigger. That is, the occurrence of certain events may trigger the generation of a random password. Thus, the password is reset periodically from a first random password, such as “!a1rT56%$uS89se!” to “8L#k7je&#3ds70%Q” as depicted in FIG. 1 upon occurrence of a particular generation trigger. The trigger may take any variety of forms. For example, the generation trigger may an expiration of a time interval. That is, the random password may be generated periodically. The time interval may be an hour, a day, a week, or a month. As such, the password is reset every hour, day, week, or month. Thus, the random password generation device (100) increases system security and protects against cyberattacks by changing the password on a schedule such that even were a malicious user to gain access to the password, such a user would not be able to hack, or otherwise gain unauthorized access to the underlying data based on the revolving nature of the random password. While particular reference is made to particular intervals, the random password may be generated according to any interval.

To further increase security, the time interval itself may be random. That is, rather than changing on a set schedule, the time interval after which a password changes may itself be random. For example, the initial password (112) of “Password1234” may change to “!a1rT56%$uS89se!” after one hour. This random password may change from “!al rT56%$uS89se!” to “8L#k7je&#3ds70%Q” after two hours. Accordingly, the random password generation device (100) further protects the underlying content by removing any regular schedule by which the password changes, thus further protecting the password and underlying content form cyberattack or other unauthorized access.

In other examples, the generation trigger may be a forced event. That is, rather than relying on some automatic predetermined schedule, a user may initiate a random password generation. For example, the generation trigger may be a computing device reboot. Accordingly, if a user is concerned that a password may have been compromised, the user may simply reboot the computing device to initiate the random password generation. In another example, the generation trigger may be an installation of the instructions on the computing device. That is, each time the generate random passwords instructions (108) are installed on a computing device (100) a random password may be generated. Thus, the present random password generation device (100) solves the problem of password hacking by 1) removing stored passwords from the computing device and 2) increasing network and data security by implementing a revolving random password generation wherein a user cannot ascertain the particular time-specific random password.

To allow access to the computing device, application, or open-source program code, the memory device (104) includes reset random password instructions (110) which, responsive to entry of a predetermined user command, reset the random password to a user-defined password. That is, an authorized user may access a user interface which resets the random password to a password of the authorized user's selection such that the authorized user may enter the computing device, application, or open-source code application to perform an intended function.

The instructions may be grouped into multiple modules. For example, a first module, or first instruction set may execute the determine parameter instructions (106) and generate random password instructions (108) to reset the password and randomize it. The second instruction set may execute the reset random password instructions (110) to reset the random password with the temporary user-defined password. That is, an administrator or other user may execute the first instruction set to implement the randomization of passwords and may execute the second instruction set to enter a password to gain access to the underlying content.

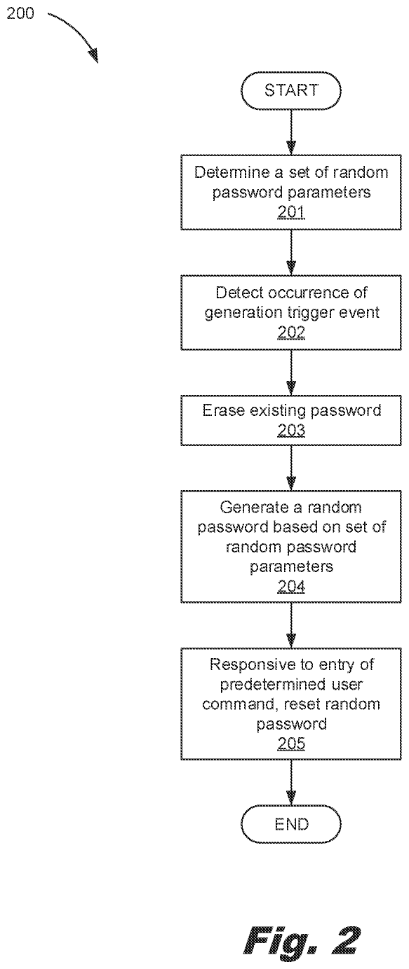

FIG. 2 is a flowchart of a method (200), for generating a random password, according to an example of the principles described herein. According to the method (200), a set of random password parameters are determined (block 201). As described above, these random password parameters are used in the generation of the random passwords. Specifically, the random password parameters are criteria that the random password is set to comply with. There may be any number of parameters including, but not limited to 1) password length, 2) the presence, quantity, and type of special characters, 3) the presence, quantity, and type of numeric characters, and 4) the presence and quantity of uppercase and/or lowercase characters. While particular reference is made to specific random password parameters, other random password parameters may be implemented as in accordance with the present specification.

Each parameter may have a particular value. For example, the password length value may have a numeric value indicating the minimum and/or maximum password length. As such determining (block 201) the set of random password parameters includes identifying a numeric value, Boolean value, or other value associated with such.

In an example, the random password parameters themselves may be randomly adjusted. That is, in an example the random password parameters are not static, but are dynamic and potentially randomly adjustable. For example, during a first random password generation, the password length parameter may be 10 characters. During a second random password generation, the password length parameter may be 12 characters. The random adjustment of the password parameters further protects a computing device against cyberattack and increases computing security. While particular reference is made to a particular parameter that changed in a particular fashion, any of the random password parameters may be randomly changed in any fashion, for example to different values indicating a presence, quantity, and/or type of character. The frequency with which the random password parameters change may also be random. That is, in some cases, the random password parameters may change based on a set schedule and in another example the random password parameters may change based on a random schedule.

Generation of a random password may be triggered by some event. Accordingly, the random password generation device (100) detects (block 202) the occurrence of a generation trigger event. As described above, such a generation trigger event may be a user-initiated trigger event, such as a forced reboot of a computing device. In other examples, the generation trigger event may be automatic. For example, expiration of a timer may trigger password generation. As with the parameters, a timer-based generation trigger event may have a number of values. For example, these values may be hourly, daily, weekly, and monthly. While particular reference is made to particular time intervals, any number of values may be implemented in accordance with the principles described herein.

In some examples, the generation trigger event may occur multiple times in a day. As such, the random password generation device enhances system security by providing a random and frequently changing password which prevents unauthorized access to the underlying content as a user, if able to discern a random password which is unlikely, would have to discern the random password in a short amount of time, less than one day for example every hour, before a subsequent generation cycle.

Whatever the generation trigger event may be, upon detection of such, the random password generation device (100), and specifically the processor (102) executing the generate random password instructions (108) erases (block 203) the existing password and generates (block 204) a random password based on the set of random password parameters. That is, an existing password that is stored on a memory device 1) takes up space on the memory device (104) and 2) is subject to misappropriation as any stored value may be hacked or maliciously acquired by an unauthorized party. Accordingly, by erasing (block 203) an existing password from the memory device (104), misappropriation of a user-defined password is precluded. Moreover, by not relying on a device-stored password to access the underlying content, the present system increases system security and makes the computing device more robust against cyberattack. Thus, system security is improved.

As described above, in generating (block 204) the random password, the random password generation device (100) considers the random password parameters. Specifically, the random password is generated (block 204) to have a password length that complies with a minimum/maximum password length parameter, include a predetermined quantity and type of special characters and numeric characters to comply with the special character parameter and number parameter respectively, and to include a predetermined quantity of upper and/or lowercase characters to comply with the character case parameter. Again, while particular reference is made to particular parameters, other random password parameters may be implemented in accordance with the principles described herein.

Responsive to entry of a predetermined user command, the random password generation device (100) may reset (block 205) the random password. That is, a random password is not known to any party so that no party, nor automated hacking program, can acquire the random password. However, from time to time an authorized user, such as an administrator, may desire to access the underlying content. For example, an administrator with root privileges may desire to access open-source program code to effectuate some code change. The random password generation device (100) enables such access by executing random password instructions (110) and providing an interface wherein an administrator, with administrator privileges can reset the random password with a temporary password so that the administrator can have access to the underlying content. Upon use of the underlying content by the authorized user, the temporary user-defined password may be subject to the random password generation device (100). That is, the temporary user-defined password may be replaced with a random password generated by the random password generation device (100), responsive to a generation trigger event which may be an automatic or user-initiated generation trigger event.

Accordingly, as described herein, the method (200) improves system security by avoiding reliance on a hackable memory-device stored password, reduces a load on the memory device (104) by not storing passwords thereon, and reduces bandwidth of memory device accesses as the passwords are not stored or retrieved thereon.

The random password generation device (100) prevents access to the underlying content when a password other than the random password is entered. By comparison, responsive to the setting of a temporary user-defined password, the random password generation device (100), and more specifically the processor (102) executing the reset random password instructions (110), allows the user to access and operate on the underlying content.

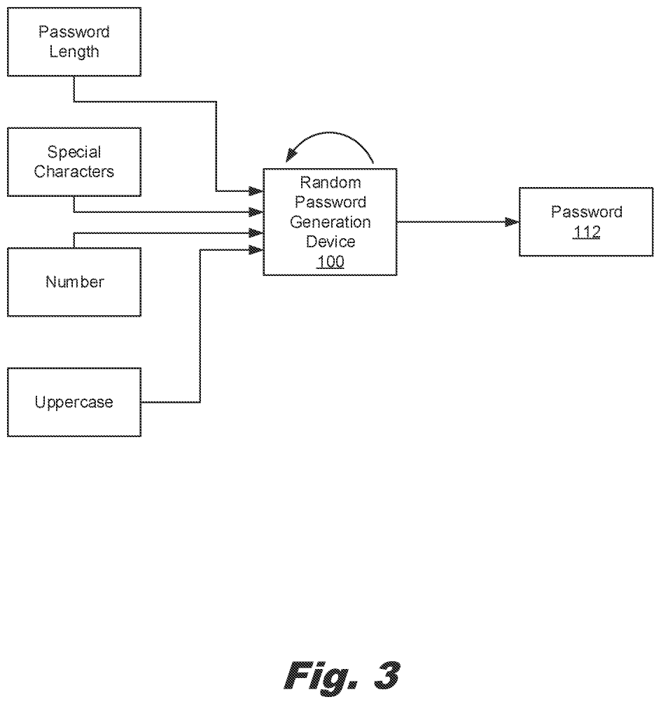

FIG. 3 is a diagram of a device (100) for generating a random password (112), according to an example of the principles described herein. As described above, the random password generation device (100) receives from a user, or otherwise acquires, a set of random password parameters such as a password length parameter, a special character parameter, a number parameter, and a character case parameter. The processor (102), executing generate random password instructions (108), generates a random password based on these parameters. Upon the occurrence of some generation trigger event, the random password generation device (100) executes again to generate yet another random password, thus increasing efficiency at enforcing data access rights as unauthorized users are precluded from accessing the underlying content, which may be open-source program code. As described above, the generation trigger event may be of a variety of types including when the program instructions are installed, when the computing device boots, and at random password reset intervals. Note that erasing the existing password may include erasing a randomly generated password. That is, the random password generation device (100) repeatedly generates random passwords and erases other randomly created passwords. Accordingly, even in the very unlikely event that a user ascertains a first random password, the user may be blocked from accessing the underlying content as the first random password is replaced with a second random password.

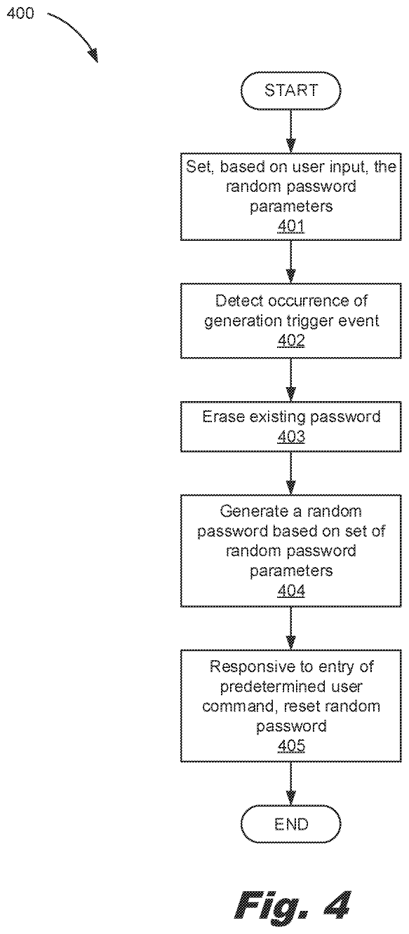

FIG. 4 is a flowchart of a method (400) for generating a random password, according to an example of the principles described herein. As described above, the random password generation device (100) may determine the set of random password parameters. In an example, determining the random password parameters includes setting (block 401) the set of random password parameters based on user input. That is, a user may enter the random password parameters.

As a particular example, each parameter may have a default value and the user may alter that default value. For example, to set the password length parameter, the user may enter the command, “root/users/pw_rules/length : number” where the number is the length of the password and may have a default value of 12. To set the special character parameter, the user may enter the command, “root/users/pw_rules/special_character : Boolean” where the default value is “1” indicating there is at least one special character to be provided in the random password. To set the number parameter, the user may enter the command, “root/users/pw_rules/number : Boolean” where the default value is “1” indicating there is at least one number is to be provided in the random password. To set the character case parameter, the user may enter the command “root/users/pw_rules/upper_case : Boolean” where the default “1” indicates there is to be at least one uppercase character provided in the random password. The user may also set the time interval by which the random password is generated. For example, the user may enter the command “root/users/pw_rules/interval : String” where the value may be none, hourly, daily, weekly, or monthly with a default value of hourly. As noted above, while particular reference is made to particular parameters, a variety of parameters and parameter values may be set based on user input.

Accordingly, the random password generation device (100) may detect (block 402) the occurrence of a generation trigger event, erase (block 403), an existing password and generate (block 404) a random password as described above in connection with FIG. 2. Also as described above in connection with FIG. 2, the random password generation device (100) may reset (block 405) the random password with a temporary user-defined password responsive to entry of a predetermined user command, such as a line of program code in an open-source interface.

Accordingly, as described above, the method (400) enhances system security, reduces the load on the memory device (104), and provides for improved memory access bandwidth. Specifically, as user-defined passwords are not saved on the memory device (104), but instead replaced with randomly generated passwords, less space is used up on the memory device (104) to provide system security. Moreover, as the present system avoids database-stored passwords, memory accesses to retrieve those passwords are bypassed, thus reducing processing load and increasing processing bandwidth for other endeavors.

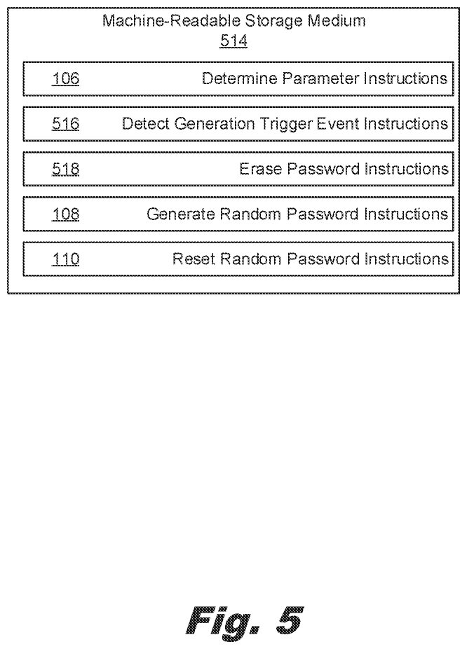

FIG. 5 depicts a non-transitory machine-readable storage medium (514) for generating a random password, according to an example of the principles described herein. To achieve its desired functionality, the random password generation device (100) includes various hardware components. Specifically, the random password generation device (100) includes a processor (102) and a machine-readable storage medium (514). The machine-readable storage medium (514) is communicatively coupled to the processor (102). The machine-readable storage medium (514) includes several instructions (106, 516, 518, 108, 110) for performing a designated function. In some examples, the instructions may be machine code and/or script code.

The machine-readable storage medium (514) causes the processor (102) to execute the designated function of the instructions (106, 516, 518, 108, 110). The machine-readable storage medium (514) can store data, programs, instructions, or any other machine-readable data that can be utilized to operate the random password generation device (100). Machine-readable storage medium (514) can store machine-readable instructions that the processor (102) of the random password generation device (100) can process, or execute. The machine-readable storage medium (514) can be an electronic, magnetic, optical, or other physical storage device that contains or stores executable instructions. Machine-readable storage medium (514) may be, for example, Random-Access Memory (RAM), an Electrically Erasable Programmable Read-Only Memory (EEPROM), a storage device, an optical disc, etc. The machine-readable storage medium (514) may be a non-transitory machine-readable storage medium (514).

In some examples, the instructions may be grouped into different instruction sets. A first program instruct set may include determine parameter instructions (106), detect generation trigger event instructions (516), erase password instructions (518), and generate random password instructions (108). Determine parameter instructions (106), when executed by the processor (102), cause the processor (102) to determine a set of random password parameters wherein the set of random password parameters defines a generated random password. Detect generation trigger event instructions (516), when executed by the processor (102), cause the processor (102) to detect occurrence of a generation trigger event. Erase password instructions (518), when executed by the processor (102), cause the processor (102) to erase an existing password. Generate random password instructions (108), when executed by the processor (102), cause the processor (102) to generate a random password based on the set of random password parameters, wherein the random password is to grant a user access to an application.

A second program instruct set may include reset random password instructions (110) which, when executed by the processor (102), cause the processor (102) to reset the random password to a user-defined password responsive to entry of a predetermined user command.

As described above, such a device, method, and machine-readable storage medium may, for example, 1) provide a computing device with greater data security; 2) protects against cyberattack; 3) are more robust against nefarious attempts to circumvent password authentication; 4) alleviate complications arising from forgotten passwords; 5) provide simple access to authorized users; 6) uses up less memory resources; and 7) increases processing bandwidth. However, it is contemplated that the device, method, and machine-readable storage medium disclosed herein may address other matters and deficiencies in a number of technical areas, for example.

What is claimed is:

1. A random password generation device, comprising:
a processor;
a memory device communicatively coupled to the processor, the memory device comprising instructions executable by the processor, the instructions comprising:
instructions to determine a random password parameter, wherein the random password parameter defines a generated random password;
instructions to, responsive to a generation trigger, generate a random password based on the random password parameter, wherein the random password is to grant a user access to an application; and
instructions to, responsive to entry of a predetermined user command, reset the random password to a user-defined password.

2. The random password generation device of claim 1, wherein the generation trigger is an expiration of a time interval.

3. The random password generation device of claim 2, wherein the time interval comprises an hour, a day, a week, or a month.

4. The random password generation device of claim 2, wherein the time interval is random.

5. The random password generation device of claim 1, wherein the generation trigger is a computing device reboot.

6. The random password generation device of claim 1, wherein the generation trigger is installation of the instructions on a computing device.

7. The random password generation device of claim 1, wherein the random password and the user-defined password are to grant the user access to alter an operating system of a computing device.

8. The random password generation device of claim 1, wherein the random password and the user-defined password are system passwords to initialize a computing device.

9. A method, comprising:
determining a set of random password parameters, wherein the set of random password parameters defines a generated random password;
detecting occurrence of a generation trigger event;
responsive to the occurrence of the generation trigger event:
erasing an existing password; and
generating a random password based on the set of random password parameters, wherein the random password is to grant a user access to an application; and
responsive to entry of a predetermined user command, resetting the random password to a user-defined password.

10. The method of claim 9, wherein the generation trigger event is a user-initiated trigger event.

11. The method of claim 9, wherein the generation trigger event occurs multiple times in a day.

12. The method of claim 9, further comprising setting, based on user input, the set of random password parameters.

13. The method of claim 11, wherein the set of random password parameters comprises:
a password length parameter;
a special character parameter;
a number character parameter;
a character case parameter; or
a combination thereof.

14. A non-transitory machine-readable storage medium encoded with instructions executable by a processor, the machine-readable storage medium comprising instructions to:
execute a first program instruction set to:
determine a set of random password parameters, wherein the set of random password parameters defines a generated random password;
detect occurrence of a generation trigger event;
responsive to the occurrence of the generation trigger event:
erase an existing password; and
generate a random password based on the set of random password parameters, wherein the random password is to grant a user access to an application; and
execute a second program instruction set to responsive to entry of a predetermined user command, reset the random password to a user-defined password.

15. The non-transitory machine-readable storage medium of claim 14, further comprising instructions executable by a processor, to randomly adjust the random password parameters.
